(19) United States
(12) Patent Application Publication
(10) Pub. No.: US 2007/0258614 A1
(43) Pub. Date: Nov. 8, 2007

(54) HEADPHONE AND PORTABLE SPEAKER SYSTEM

(75) Inventor: Eric Aaron Langberg, Milford, PA (US)

Correspondence Address: GREENBERG TRAURIG, LLP, 1750 TYSONS BOULEVARD, 12TH FLOOR, MCLEAN, VA, 22102, US

(73) Assignee: Altec Lansing, a Division of Plantronics, Inc., Milford, PA (US)

(21) Appl. No.: 11/743,828

(22) Filed: May 3, 2007

Related U.S. Application Data
(60) Provisional application No. 60/796,898, filed on May 3, 2006.

(51) Int. Cl. H04R 25/00

(52) U.S. Cl. 381/379; 381/370

(57) ABSTRACT

A dual-mode speaker system comprising a selector that selects between a first audio mode and at least one other mode; an audio pack for receiving an input signal from an external device, and for converting at least a portion of the input signal into a first signal for audio reproduction by a speaker driver when the selector is in the first mode, and for converting at least a portion of the input signal into a second signal for audio reproduction when the selector is not in the first mode; a speaker driver connected to the audio pack, the speaker driver adapted to receive the first and/or second signal for audio reproduction and to output an audio reproduction corresponding to the received signal; wherein the selector is operated by changing the orientation of the speaker driver with respect to at least one other portions of the system.

### CROSS-REFERENCE TO RELATED APPLICATIONS

This application claims priority to U.S. Provisional Patent Application Ser. No. 60/796,898 filed May 3, 2006, which is incorporated herein by reference in its entirety.

This application includes material which is subject to copyright protection. The copyright owner has no objection to the facsimile reproduction by anyone of the patent disclosure as it appears in the Patent and Trademark Office files or records, but otherwise reserves all copyright rights whatsoever.

### BACKGROUND OF THE INVENTION

Headphones are capable of providing good sound quality, but are designed to be worn directly on or in the ears to achieve their desired frequency response and sound pressure level. While sounds can still be heard even when headphones are removed from the listener's head, the headphones do not provide high enough sound pressure levels for enjoyable listening, and the frequency response is degraded from that which is achieved when worn on the head. Headphones, therefore, do not provide a reasonable method for listening to audio without wearing them on the head.

An alternative solution for listening to audio is via a set of amplified (active) or unamplified (passive) speakers. These can provide sufficient sound pressure levels and a much improved frequency response, and the audio may be heard by anyone within listening range of the speakers. Portable speakers are typically smaller, active speaker systems designed for audio reproduction where the listener wants to leave the speakers stationary while the listener(s) moves about in an environment. Unfortunately, a traveler or other user who may want to listen privately in some situations and “publicly” in others must carry both headphones and a set of portable speakers to meet these needs.

### SUMMARY OF THE INVENTION

Accordingly, the present invention is directed to a headphone and portable speaker system that substantially obviates one or more of the problems due to limitations and disadvantages of the related art.

The invention provides a set of amplified headphones that function as normal headphones when worn on the head but which can be operated as a higher power portable speaker system with corrected frequency response when removed from the head. This allows the user to configure the system for the appropriate application without the need to carry two separate devices.

An object of the present invention is to provide a multi-mode speaker system which conveniently allows the user to both play the audio for themselves in the form of headphone-like audio reproduction, and alternatively for an audience in the form of speaker-like audio reproduction.

This invention provides a simple, cost effective way for a user to carry one device which can function as a headphone or a portable speaker system. While mainly intended for use with portable audio devices, the addition of a wireless means for audio input would improve its usability in a more fixed environment, such as a home.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of at least one embodiment of the invention.

In the drawings:

FIG. 1 is a front view of an exemplary embodiment in headphone mode.

FIG. 2 is a side view of an exemplary embodiment in speaker mode.

FIG. 3 is a front view of an exemplary embodiment in speaker mode.

FIG. 4 is a front view of an exemplary embodiment in headphone mode.

FIG. 5 is a top view of an exemplary embodiment in headphone mode.

FIG. 6 is a side view of an exemplary embodiment in headphone mode.

FIG. 7 is a perspective view of an exemplary embodiment in headphone mode.

FIG. 8 is a front view of an exemplary embodiment in speaker mode.

FIG. 9 is a perspective view of an exemplary embodiment in speaker mode.

FIG. 10 is a side view of an exemplary embodiment in headphone mode.

### DETAILED DESCRIPTION OF EMBODIMENTS OF THE INVENTION

Reference will now be made in detail to various embodiments of the present invention, examples of which are illustrated in the accompanying drawings.

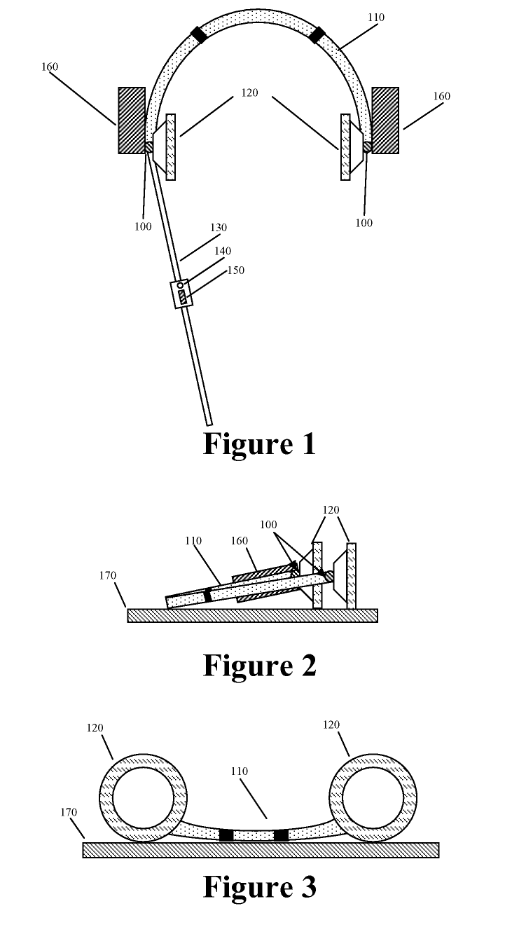

FIG. 1 is a front view of an embodiment in headphone mode. In an embodiment, a pair of headphones 120 are connected by a headband 110. Audio packs 160 receive an input signal from an external device via wire 130 and convert the input signal into an appropriate signal for audio reproduction by headphones 120. Wire 130 is not shown in FIGS. 2 and 3 for purposes of clarity. In addition, one audio pack 160 is not shown in FIG. 2, also for the purpose of clarity.

Headphones 120 preferably employ speaker drivers capable of operating at high enough power to permit operation as a portable speaker system. Drivers typically used in headphones have a relatively high impedance to minimize loading on the driving amplifier. Power levels for typical headphones run from a few milliwatts to a few hundred milliwatts. The drivers typically used in headsets cannot handle the higher power levels required to operate as a portable speaker, typically a few watts or more, without substantial non-linearity or damage to the driver. An embodiment of the invention employs a high power driver designed for portable speaker applications. An embodiment of the invention employs a driver designed for both low power and high power applications.

As illustrated in FIGS. 2 and 3, the ear cups of headphones 120 can be moved from the typical headphone listening position illustrated in FIG. 1 to a position where headphones 120 both radiate in generally the same direction for use as a portable speaker system. In the portable speaker mode illustrated in FIGS. 2 and 3, headband 110 can function as a stand, thereby allowing the headset to be easily positioned on table 160.

In an embodiment, as the earcups of headphone 120 are rotated toward a generally common direction, switch 100 can sense the change in positions, and thus select a speaker operating mode. Similarly, as the earcups of headphone 120 are rotated toward a generally inwardly opposing direction, switch 100 senses the change in position, and thus selects a headphone operating mode. In an embodiment, a power amplifier in audio pack 160 automatically adjusts the gain, and an equalizer adjusts the frequency response and other characteristics of the incoming signal based on the selected operating mode. Audio pack 160 may also include at least one battery, by which the amplifier and other components within audio pack 160 can receive power. In an embodiment, switch 100 may be a manually-operable switch that allows the user to select the desired operating mode. Such mode selection may be made independent of the position of the headphone earcups.

In an embodiment, the power amplifier needed to operate the system in speaker mode can be capable of driving the speakers at levels that could be dangerous when operating as headphones. For this reason, an embodiment the system employs a safety mechanism to protect the listener's hearing. In such embodiment, each headphone 120 has at least one switch 100 associated with it, and when any one of the switches 100 indicate that headphone mode is selected, the headphone operating mode is used, and both speakers automatically reproduce sound according to the operating characteristics of the headphone operating mode. In an embodiment, additional or alternative safety mechanisms can be employed to prevent the inwardly opposing headphone cups 120 from operating in the speaker operating mode.

FIGS. 1-3 illustrate two audio packs 160, one for each side of the headset. This allows the weight to be more evenly balanced on the listener's head. Although the figures illustrate two audio packs 160, alternative arrangements, including, without limitation, a single audio pack located on the headset, a single audio pack located in line with the cord, an audio pack contained in a unit that is removably attachable to the listener's belt or waistband or an audio pack positioned near the middle of, or integrated into, headband 110, can be substituted therefor without departing from the spirit or the scope of the invention.

Referring again to FIG. 1, cable 130 is illustrated as connecting to the left-hand audio pack 160. In an embodiment, the signal for the right-hand channel is transmitted to the right-hand audio pack 160 via a cable within headband 110. In an embodiment, the signal for the right-hand channel can be transmitted to the right-hand audio pack 160 from the left-hand audio pack 160 via an ultrasonic transducer, Bluetooth transceiver, or other wireless transmission means. In an embodiment, cable 130 may run to both the left-hand and right-hand audio packs. Although FIG. 1 illustrates a wired communications means, alternative communications means, including, without limitation, wireless communications means such as radio frequency carrier, radio frequency spread spectrum, Bluetooth, International Electrical and Electronics Engineers standard number 802.11, infrared, electro-magnetics, and the like, can be substituted therefor without departing from the spirit or the scope of the invention. Similarly, although the description herein focuses on traditional, analog audio signals being carried by cable 130, it should be apparent to one skilled in the art that alternative input signals, including, without limitation, digital signals such as those based on the Universal Serial Bus standard, the FireWire standard, or the SPDIF standard, can be substituted therefor without departing from the spirit or the scope of the invention, such as by adding the appropriate circuitry to audio pack 160.

An embodiment of the invention also includes a housing 135 which can comprise microphone 140 and/or mute button 150. Although microphone 140 and mute button 150 are illustrated as integrated into or connected to wire 130, microphone 140 and mute button 150 can alternatively be located in other portions of the headset as is known in the art, such as, without limitation, on a boom (not shown) connected to the headset. These can allow the system to be used in a variety of environments and for a variety of purposes, including use as a speakerphone when operating in the speaker operating mode, or phone or gaming headset when operating in the headphone operating mode.

The inclusion of at least one noise cancellation microphone (not shown) allows an embodiment of the system to cancel out external noises, thereby improving perceived sound quality when the system operates in headset mode, as is well known in the art. The noise cancellation microphone can also be used when the headset is operating in speaker mode. In an embodiment, when the headset is worn while in speaker mode, such as around a performer's neck, the performer is able to sing along with or otherwise perform as the sounds are played from the speakers, and the performer's voice can be amplified by the speakers.

Audio pack 160 may also include one or more signal level controls (not illustrated). The signal level controls can allow the user to adjust audio signal levels before the audio signal is presented to headphones 120. Such signal level adjustments may be made passively or actively, and may include, but are not limited to, volume adjustments, equalization, balance, and the like. An example of a passive signal level adjustment includes adding a variable resistor in series with at least one of headphones 120, thereby allowing the user to decrease the volume. Active signal level adjustments can be made, for example, by adjusting the gain on an amplifier associated with the headset. Although signal level controls are described as part of audio pack 160, alternative signal level control locations, such as, without limitation, in cord 130 or headband 110, may be substituted therefor without departing from the spirit or the scope of the invention.

Audio pack 160 may also include one or more adapters for connecting the system to additional components. Such additional components may include, without limitation, external speakers, external signal level controls, and the like.

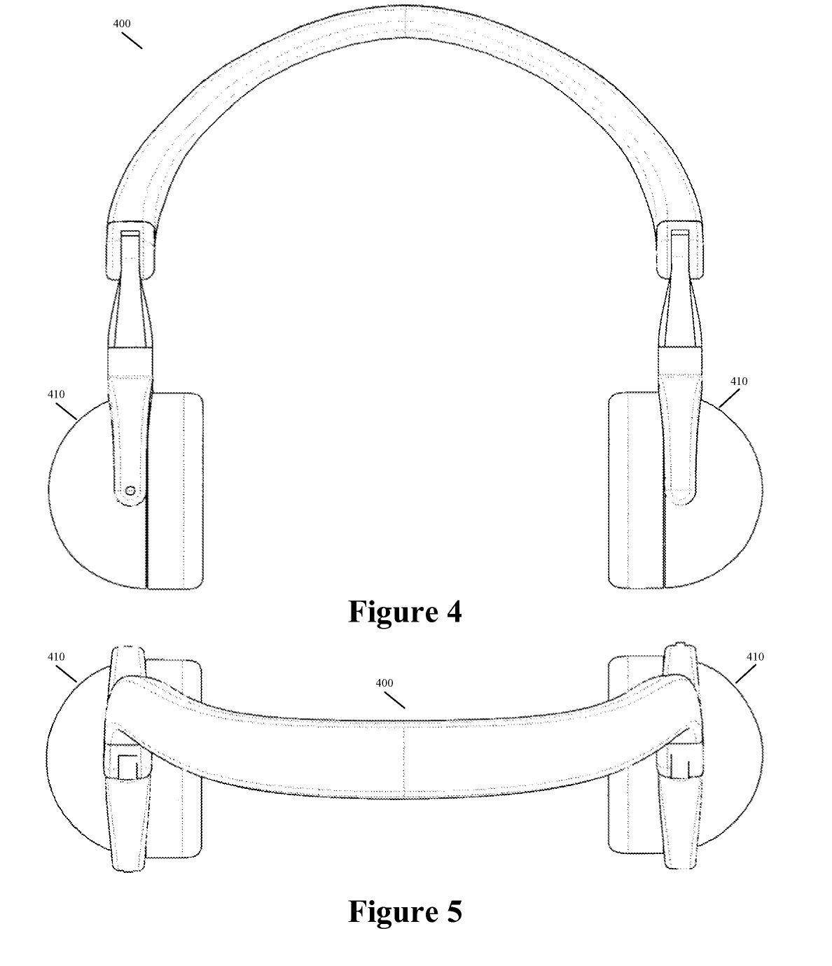

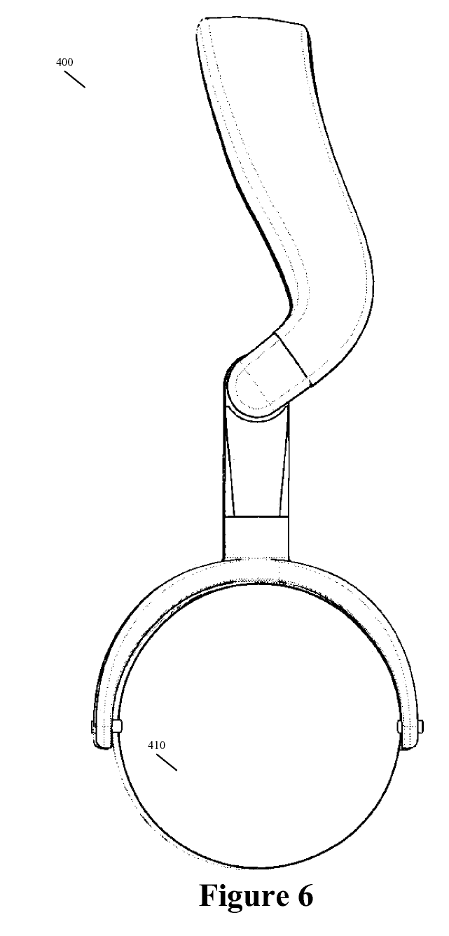

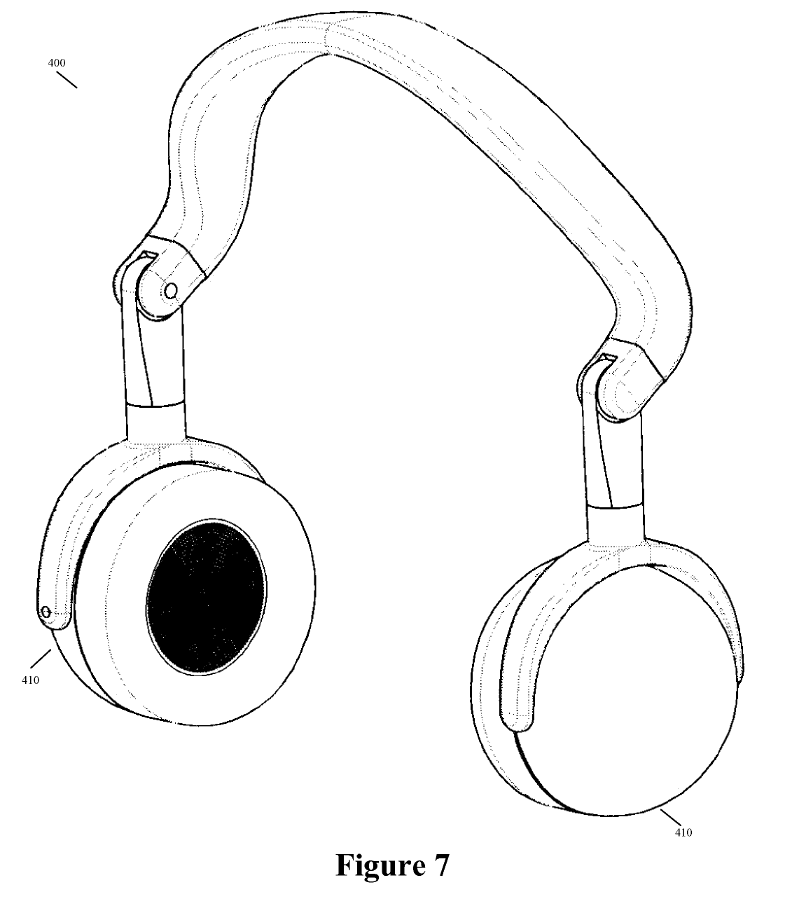

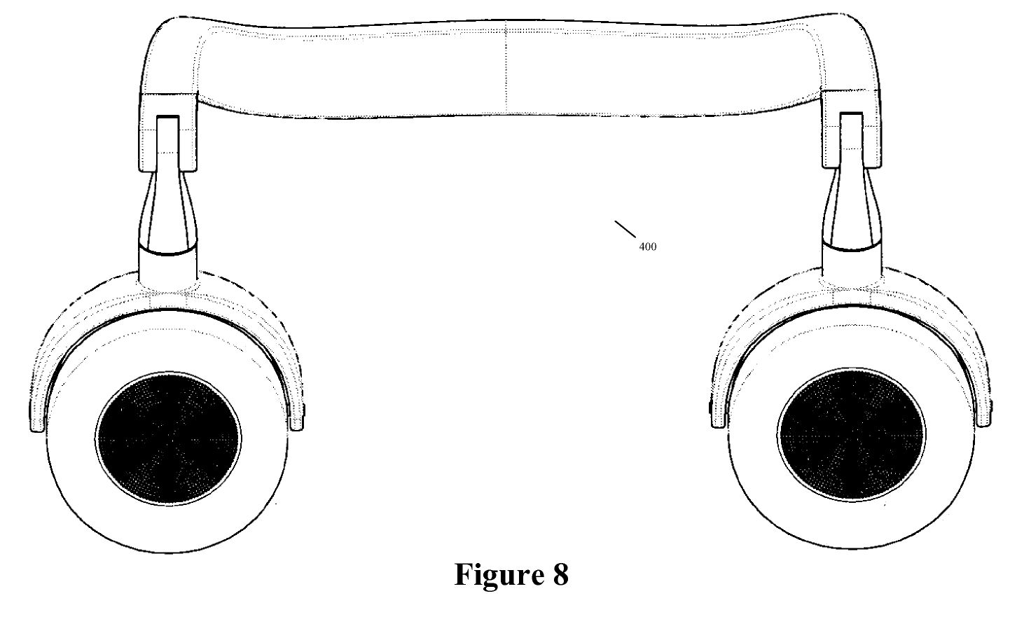

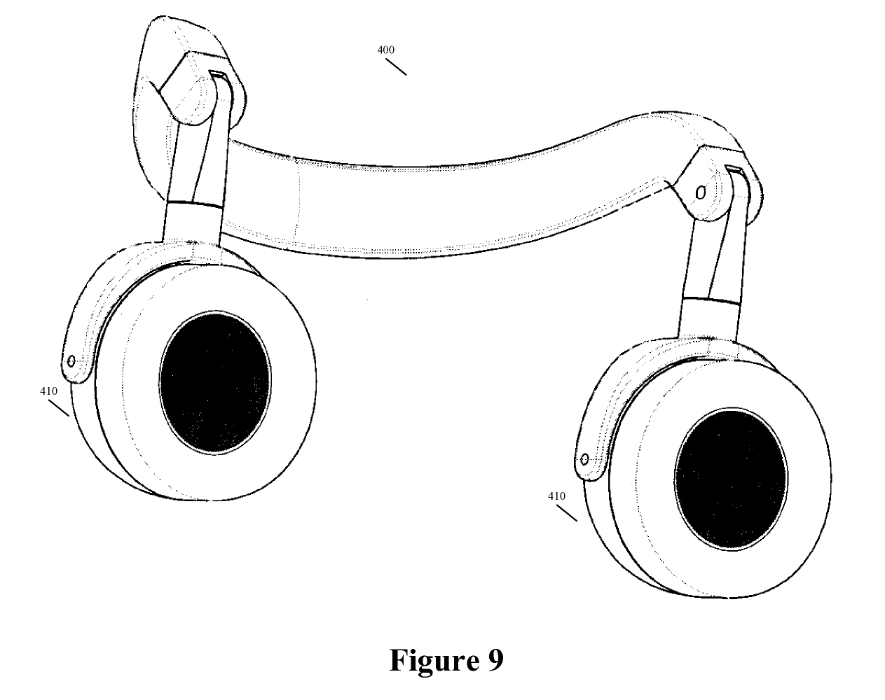

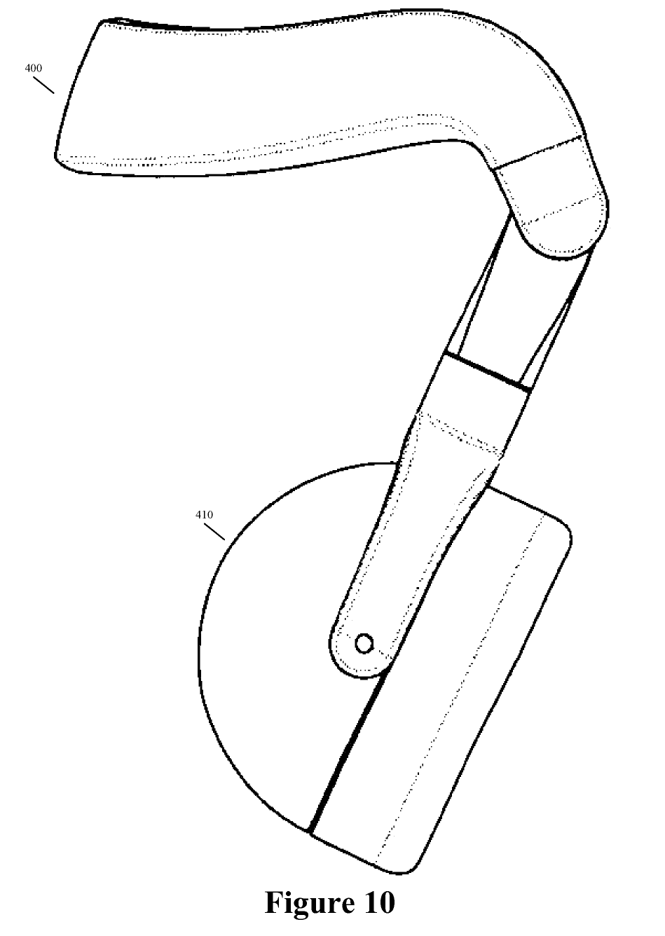

FIGS. 4-7 are alternative views illustrating a headphone embodiment wherein at least one audio pack has been integrated into housing 410. In the illustrated embodiment, headset 400 is a wireless headset which can use Bluetooth-enabled, spread-spectrum, or other technologies to receive an audio signal from an audio source. FIGS. 8-10 illustrate the embodiment of FIGS. 4-7 when operating in speaker mode.

While the invention has been described in detail and with reference to specific embodiments thereof, it will be apparent to those skilled in the art that various changes and modifications can be made therein without departing from the spirit and scope thereof. Thus, it is intended that the present invention cover the modifications and variations of this invention provided they come within the scope of the appended claims and their equivalents.

I claim:

1. A dual-mode speaker system comprising:
a selector that selects between a first audio mode and at least one other mode;
an audio pack for receiving an input signal from an external device, and for converting at least a portion of the input signal into a first signal for audio reproduction by a speaker driver when the selector is in the first mode, and for converting at least a portion of the input signal into a second signal for audio reproduction when the selector is not in the first mode;
a speaker driver operatively connected to the audio pack, the speaker driver being adapted to receive the first signal for audio reproduction or the second signals for audio reproduction and to output an audio reproduction corresponding to the received first or second signal; and
wherein the selector is operated by changing the orientation of the speaker driver with respect to at least one other portions of the dual-mode speaker system.

2. The dual-mode speaker system of claim 1, wherein the audio pack further converts at least a portion of the input signal into a third signal for audio reproduction by a speaker driver when the selector is in the first mode, and for converting at least a portion of the input signal into a fourth signal for audio reproduction when the selector is not in the first mode, the dual-mode speaker system further comprising:
a second speaker driver operatively connected to the audio pack, the second speaker driver being adapted to receive the third signal for audio reproduction or the fourth signal for audio reproduction and to output an additional audio reproduction corresponding to the received third or fourth signal.

3. The dual-mode speaker system of claim 1, further comprising a microphone, wherein the microphone provides a microphone input to the audio pack.

4. The dual-mode speaker system of claim 3, wherein the audio pack comprises noise cancellation circuitry, and wherein the audio pack uses the microphone input to adjust the sound presented by the dual-mode speaker system.

5. The dual-mode speaker system of claim 3, wherein the audio pack further comprises audio signal transmission circuitry, wherein the audio transmission circuitry receives the microphone input and converts the sound into a form receivable by the external device.

6. A dual-mode speaker system comprising:
an input signal having left and right channels of audio information;
a processor for processing the input signal and for providing an output signal suitable for a pair of speaker drivers;
a pair of speaker drivers, the pair of speaker drivers having a first position wherein the drivers are oriented to be generally facing each other at a distance between 5 and 10 inches apart and having a second position wherein the drivers are oriented in a manner that is not generally facing each other at a distance between 5 and 10 inches apart;
a sensor for detecting that the drivers are oriented in the second position; and
wherein the processor provides the output signal at a first level when the sensor does not detect that the drivers are oriented in the second position, and provides the output signal at a second level when the sensor detects that the drivers are oriented in the second position.

7. The dual-mode speaker system of claim 6, wherein the first level is lower than the second level.

8. The dual-mode speaker system of claim 7, wherein the output signal is equalized to provide an altered frequency response when the sensor detects that the drivers are oriented in the second position.

9. The dual-mode speaker system claimed in claim 7, wherein the output signal comprises an altered frequency response when the sensor does not detect that the drivers are oriented in the second position.

10. The dual-mode speaker system of claim 6, wherein the output signal comprises a first altered frequency response when the sensor detects that the drivers are oriented in the second position and comprises a different altered frequency response when the sensor does not detect that the drivers are oriented in the second position.

11. The dual-mode speaker system of claim 6, further comprising a microphone, wherein the microphone provides a microphone input signal to the processor.

12. The dual-mode speaker system of claim 11, wherein the output signal provided by the processor comprises an a noise cancellation audio signal, and wherein the noise cancellation audio signal is based, at least in part, on the microphone input signal.

13. The dual-mode speaker system of claim 11, further comprising audio signal transmission circuitry, wherein the audio transmission circuitry receives the microphone input signal and converts the sound into a form receivable by an external device.

14. The dual-mode speaker system of claim 13, wherein the processor comprises the audio signal transmission circuitry.

15. A dual-mode speaker system comprising:
a selector that selects between a first audio mode and at least one other mode;
an audio pack for receiving an input signal from an external device, and for converting at least a portion of the input signal into a first signal for audio reproduction by a speaker driver when the selector is in the first mode, and for converting at least a portion of the input signal into a second signal for audio reproduction when the selector is not in the first mode; and,
a speaker driver operatively connected to the audio pack, the speaker driver being adapted to receive the first signal for audio reproduction or the second signals for audio reproduction and to output an audio reproduction corresponding to the received first or second signal.

16. The dual-mode speaker system of claim 15, wherein the selector comprises a switch that operates independent of the speaker driver orientation.

17. The dual-mode speaker system of claim 15, wherein the audio pack further converts at least a portion of the input signal into a third signal for audio reproduction by a speaker driver when the selector is in the first mode, and for converting at least a portion of the input signal into a fourth signal for audio reproduction when the selector is not in the first mode, the dual-mode speaker system further comprising:
a second speaker driver operatively connected to the audio pack, the second speaker driver being adapted to receive the third signal for audio reproduction or the fourth signal for audio reproduction and to output an additional audio reproduction corresponding to the received third or fourth signal.

18. The dual-mode speaker system of claim 15, further comprising a microphone, wherein the microphone provides a microphone input signal to the audio pack.

19. The dual-mode speaker system of claim 15, wherein the audio pack comprises noise cancellation circuitry, and wherein the noise cancellation circuitry uses the microphone input to adjust the sound presented by the dual-mode speaker system.

20. The dual-mode speaker system of claim 19, wherein the audio pack further comprises audio signal transmission circuitry, wherein the audio transmission circuitry receives the microphone input and converts the sound into a form receivable by the external device.

21. A dual-mode speaker system comprising:
an input signal having left and right channels of audio information;
a processor for processing the input signal and for providing an output signal suitable for a pair of speaker drivers;
a pair of speaker drivers, the pair of speaker drivers having a first position wherein the drivers are oriented to be generally facing each other at a distance between 5 and 10 inches apart and having a second position wherein the drivers are oriented in a manner that is not generally facing each other at a distance between 5 and 10 inches apart;
a switch for indicating the orientation of the pair of speaker drivers, wherein the switch is selectable between at least two settings; and
wherein the processor provides the output signal at a first level when the switch is in a first setting and provides the output signal at a second level when the switch is in a second setting.

22. The dual-mode speaker system claimed in claim 21, wherein the first level is lower than the second level.

23. The dual-mode speaker system claimed in claim 22, wherein the output signal is equalized to provide an altered frequency response when the switch is in the second setting.

24. The dual-mode speaker system claimed in claim 22, wherein the output signal is equalized to provide an altered frequency response when switch is not in the second setting.

25. The dual-mode speaker system claimed in claim 21, wherein the output signal is equalized to provide a first altered frequency response when the switch is in the second position and to provide a different altered frequency response when the switch is not in the second setting.

26. The dual-mode speaker system of claim 21, wherein the input signal further comprises audio information from a microphone.

27. The dual-mode speaker system of claim 21, wherein the processor further receives information from a microphone and processes the information for transmission to an external device.
